(19) United States
(12) Patent Application Publication
(10) Pub. No.: US 2017/0297931 A1
(43) Pub. Date: Oct. 19, 2017

(54) SULFIDATED NANOSCALE ZEROVALENT IRON AND METHOD OF USE THEREOF

(71) Applicant: THE ROYAL INSTITUTION FOR THE ADVANCEMENT OF LEARNING/MCGILL UNIVERSITY, Montreal (CA)

(72) Inventors: Subhasis GHOSHAL, Verdun (CA); Sai Rajasekar CHANDRASEKAR RAJAJAYAVEL, Edmonton (CA)

(21) Appl. No.: 15/097,796

(22) Filed: Apr. 13, 2016

(51) Int. Cl. C02F 1/70; B82Y 40/00; B22F 1/02; B82Y 30/00; B22F 9/24; B82Y 99/00; C02F 103/06; C02F 101/36

(52) U.S. Cl. CPC C02F 1/705; B22F 9/24; B82Y 40/00; B22F 1/02; B82Y 99/00; B82Y 30/00; B22F 2301/35; B22F 2201/10; B22F 2009/245; B22F 2302/45; B22F 2303/01; B22F 2998/10; C02F 2101/36; C02F 2103/06; B22F 2304/056

(57) ABSTRACT

The present disclosure relates to sulfur-treated zerovalent iron nanoparticles and the use of same for transforming chlorinated solvent pollutants and may therefore be useful as water treatment technology for restoration of groundwater resources contaminated with toxic, chlorinated solvent pollutants.

### TECHNICAL FIELD

The present disclosure relates to sulfur-treated zerovalent iron nanoparticles and the use of same for transforming chlorinated solvent pollutants and may therefore be useful as water treatment technology for restoration of groundwater resources contaminated with toxic, chlorinated solvent pollutants.

### BACKGROUND ART

Zerovalent iron is a strong reducing agent that can effectively transform chlorinated organic compounds, such as chlorinated solvents, including TCE, to non-toxic end products. For example, trichloroethylene (TCE) is a widely used industrial solvent. Accidental spills and past improper disposal practices of TCE have led to widespread soil and groundwater contamination. Drinking water standards for TCE and many other chlorinated organic contaminants are in the range of 5 μg/L, and thus even relatively small spills have significant potential to pollute large volumes of groundwater. Zerovalent iron can transform TCE into non-toxic products such as acetylene, ethene, and ethane by the β-elimination and hydrogenation pathways. Direct sub-surface injection of nanoscale zerovalent iron (NZVI) near TCE contamination source zones has been suggested as a promising approach for rapid in situ remediation of aquifers. There are challenges to successful implementation of this technology. For example, the reactivity of NZVI is often rapidly passivated due to formation of an iron oxide shell as a result of reaction with water.

There is thus still a need to be provided with new reagents and an improved method for the de-chlorination of chlorinated organic compounds.

### SUMMARY

In accordance with the present disclosure, there is provided a sulfidated nanoscale zerovalent iron (S-NZVI) wherein said S-NZVI comprises an iron sulfide (FeS) layer on the surface of a nanoscale zerovalent iron (NZVI) and wherein an iron/sulfide molar ratio (Fe/S) is at least 0.6.

In accordance with the present disclosure, there is provided a method of producing a sulfidated nanoscale zerovalent iron (S-NZVI) comprising contacting a nanoscale zerovalent iron (NZVI) with a sulfide source in an aqueous medium.

In accordance with the present disclosure, there is provided a method for reducing a concentration of a chlorinated organic compound in an aqueous medium comprising contacting said aqueous medium with a sulfidated nanoscale zerovalent iron (S-NZVI) as defined herein.

In accordance with the present disclosure, there is provided a method for increasing the rate constant for TCE degradation of a nanoscale zerovalent iron (NZVI) in underground water, said method comprising adding into said underground water a sulfide source in the vicinity of said NZVI, whereby a sulfidated nanoscale zerovalent iron (S-NZVI) is produced.

In accordance with the present disclosure, there is provided a method for restoring or increasing an activity for TCE degradation of a passivated nanoscale zerovalent iron (NZVI), comprising contacting said NZVI with a sulfide source, wherein the sulfide source is added in an amount effective for producing a sulfidated nanoscale zerovalent iron (S-NZVI).

### BRIEF DESCRIPTION OF THE DRAWINGS

Reference will now be made to the accompanying drawings.

FIG. 1 illustrates low and high-magnification TEM images (inset) of unamended NZVI and the EDS spectra recorded from the spot marked ‘*’.

FIG. 2 illustrates TEM images and EDS spectra recorded from the spot marked ‘*’ in the TEM image, for NZVI sulfidated at Fe/S=25 mole ratio.

FIG. 3 illustrates TEM images and EDS spectra recorded from the spot marked ‘*’ in the TEM image, for NZVI sulfidated at Fe/S=12 mole ratio.

FIG. 4 illustrates narrow scans of Fe2p XPS spectra of unamended NZVI.

FIG. 5 illustrates narrow scans of Fe2p XPS spectra of sulfidated NZVI.

FIG. 6 illustrates the effect of sulfide concentration on TCE degradation in systems containing NZVI at 2.0 g/L.

FIG. 7 illustrates the surface area-normalized TCE degradation rate constants for NZVI sulfidated to different extents.

FIG. 8 illustrates the effect of sulfide concentration on TCE degradation in systems containing NZVI at 0.6 g/L.

FIG. 9 illustrates hydrogen evolution over time with and without sulfide amendment to 1.5 g/L NZVI.

FIG. 10 illustrates the effect of washing on TCE degradation rate constants for NZVI sulfidated at Fe/S=25 mole ratio and for NZVI sulfidated at Fe/S=12 mole ratio and then reamended with 0.69 and 2.08 mM sulfide solutions.

FIG. 11 illustrates Narrow scans of S 2p spectra and various resolved peaks for NZVI sulfidated at Fe/S=25 mole ratio before and after sputtering with an Argon beam.

FIG. 12 illustrates Narrow scans of S 2p spectra and various resolved peaks for NZVI sulfidated at Fe/S=12 mole ratio before and after sputtering with an Argon beam.

FIG. 13 illustrates hydrogen evolution over time with sulfide amendment to 2.0 g/L NZVI and 2.0 g/L of NZVI-Pd.

FIG. 14 illustrates reactivity of aged/passivated NZVI (10 g/L) on TCE degradation with and without sulfide amendment at a Fe/S=15 mole ratio.

### DETAILED DESCRIPTION

There is provided a sulfur-treated zerovalent iron nanoparticle (sulfidated NZVI or S-NZVI). The S-NZVI may be used in applications such as the transformation of chlorinated organic compounds, such as chlorinated solvents into non-toxic products, in particular in the field of water treatment.

A new sulfidated zerovalent iron nanoparticle is disclosed. The S-NZVI may provide an alternative water treatment technology for restoration of groundwater resources contaminated with toxic, chlorinated solvent pollutants such as trichloroethene (TCE). By reacting zerovalent iron nanoparticles (NZVI) with an inexpensive sulfur species at specific doses, the need for palladium or other bimetals for enhancement of reactivity of NZVI is eliminated. Sulfur-treated NZVI enhances the reactivity of untreated NZVI by approximately 40 times. Additionally, the sulfur species treatment results in particles with higher longevity compared to zerovalent iron alone or palladium/bimetal-doped particles. The sulfur species treatment can also reactivate aged, passivated, and unreactive NZVI.

Accordingly, sulfidated NZVI (NZVI reacted with an appropriate sulfide species at a suitable Fe/S molar ratio) slows down the loss of electrons to water, as determined by the significantly lower rate of hydrogen evolution compared to that by an unamended NZVI and palladium-doped NZVI. This makes the particles capable of degrading more mass of pollutants, such as trichloroethylene, on a per unit mass basis and lasting for a longer period of time in an aqueous environment. A reduced affinity of NZVI to water upon sulfidation, which translates to a higher reactivity to organic pollutants dissolved in water, has not been shown before.

In one embodiment, the sulfide species is HS-ion, which can be provided by a sulfide source such as sodium sulfide (Na₂S).

In one embodiment, the Fe/S molar ratio is 0.62 to 66, preferably 5 to 25 or preferably 12 to 25 or 15 to 50. The Fe/S molar ratio is the ratio of moles of Fe to the moles of S present in the whole system. Most of the Fe and S in the system are associated with the nanoparticles

The method of producing a sulfidated NZVI as defined herein involves ZVI nanoparticle size (i.e. nm size). For example, the NZVI has a size of about 150 nm from NTA measurements or less than about 1000 nm or about 970 nm from DLS measurements. This is the size of the aggregates that tend to naturally form because of the magnetic nature of the particles. The primary size of the S-NZVI from TEM images was found to be in the range of 20 to 80 nm.

In one embodiment, the method of sulfidation of NZVI is conducted in an inert atmosphere. As used herein, the inert atmosphere is one in which there is substantially no oxygen present. This can be achieved, for example, by replacing the atmospheric air by an inert gas or gas mixture such as N₂/H₂. The sulfidation of NZVI in an underground water environment may also be appropriate atmosphere.

More specifically, direct injection of reactive nanoscale zerovalent iron particles (NZVI) is considered to be a promising approach for remediation of aquifers contaminated by chlorinated organic pollutants. Accordingly, it is demonstrated herein that the extent of sulfidation of NZVI enhances the rate of de-chlorination of trichloroethylene (TCE) compared to that by unamended NZVI, and the enhancement depends on the Fe/S molar ratio. Batch experiments where TCE was reacted with NZVI sulfidated to different extents (Fe/S molar ratios of 0.62 to 66) showed that the surface-area normalized first-order TCE degradation rate constant increased up to 40 folds compared to non-sulfidated NZVI. Fe/S ratios in the range of 12 to 25 were optimal for maximizing TCE dechlorination rates, and rates decreased at both higher and lower Fe/S. In contrast, sulfidated NZVI exposed to water in the absence of TCE showed a significantly lower hydrogen evolution rate (1.64 h⁻¹ for sulfidated NZVI with Fe/S=25) compared to that by an unamended NZVI (5.81 h⁻¹), indicating that sulfidation of NZVI suppressed corrosion reactions with water. Sulfide (HS-) ions reacted rapidly with

NZVI, and X-ray photoelectron spectroscopy analyses showing formation of a surface layer of FeS and FeS₂.

More electrons from sulfidated NZVI than from unamended NZVI are conducted to TCE, likely because of greater binding of TCE on the iron sulfide reactive sites in the outer layer. Resuspending sulfidated NZVI in sulfide-free or sulfide-containing solutions altered the TCE degradation rate constants because of changes in the FeS layer thickness. Sulfidated NZVI maintained its high reactivity in the presence of multiple mono- and divalent ions and with polyelectrolyte coatings. Accordingly, sulfidation is a cost-effective strategy for enhancement of NZVI reactivity to TCE.

TCE and its degradation products were quantified by direct headspace measurement of the sample using a gas-tight syringe with mininert valve to minimize any losses. The samples were injected into a Varian CP 3800 gas chromatograph with flame ionisation detector (GC-FID) fitted with a GS-Q plot column (0.53 mm×30 m, Agilent). Samples were injected into the GC in split-less mode at 250° C. injector temperature and oven temperature held at 50° C. for 2 min, followed by a ramp of 40° C./min to 200° C. and then held at that temperature for 5 min. A calibration gas standard of 15% (v/v) ethane, ethene and acetylene in N₂ was used for quantification. Hydrogen evolution experiments were carried by adding a known mass of NZVI or sulfidated NZVI in the Mininert® vials containing 37 mL of water but without TCE. The H₂ evolved was sampled periodically as described above, followed by injection in to a HP 5890A equipped with a TCD detector fitted with a HayeSep D packed column (3 mm×10 m, Alltech). Samples were injected in split-less mode at 150° C. with constant oven temperature program (50° C.) for 3 min. Standards obtained from Sigma Aldrich were used for calibration.

In one embodiment, the hydrodynamic diameters of NZVI and sulfidated NZVI were in the range of 150 to 201 nm from NTA measurements. Hydrodynamic (Z-average) diameters of the same samples measured by DLS ranged from 960 to 1210 nm. However, TEM images show both NZVI and sulfidated NZVI with primary particle diameters between 20 to 80 nm, with a thin oxide shell of less than 4 nm in thickness.

In one embodiment, the hydrodynamic diameter of a sufidated NZVI measured from DLS is greater than or equal to about 1200 nm, or ranges from about 1050 nm to about 1400 nm. The difference in the particle size measurements by NTA and DLS arise from measurement artefacts between two techniques. The DLS size distributions are skewed towards larger sizes.

Hydrodynamic diameters of NZVI and sulfidated NZVI (Fe/S ratios of 50, 22, and 12) were in the range of 150 to 201 nm from NTA measurements (Table 1).

TABLE 1
Hydrodynamic diameters, zeta potentials and polydispersity index (PDI)
for 2.0 g/L NZVI suspensions treated with different sulfide loadings

| | NTA | DLS | | |
|---|---|---|---|---|
| | Diameter | Diameter | Zeta Potential | |
| System | (nm) | (nm) | (mV) | PDI |
| bare NZVI | 157.67 ± 9.8 | 969 ± 112 | −38.96 ± 2.87 | 0.301 ± 0.056 |
| NZVI + 0.86 mM of sulfide | 191.00 ± 8.5 | 1210 ± 194 | −43.1 ± 1.45 | 0.189 ± 0.007 |
| NVZI + 17.32 mM of sulfide | 195.33 ± 6.6 | 1045 ± 152 | −38.5 ± 1.04 | 0.269 ± 0.062 |

Hydrodynamic (Z-average) diameters of the same samples measured by DLS ranged from 960 to 1210 nm with a polydispersity index between 0.19 and 0.30. There was no trend in the particle (aggregate) size with the extent of sulfidation of NZVI. The difference in the particle size measurements by NTA and DLS arise from measurement artefacts.

The zeta potentials of both NZVI and sulfidated NZVI calculated from the electrophoretic mobility using Henry's equation (Hunter, Chapter 3—The Calculation of Zeta Potential. In Zeta Potential in Colloid Science, Hunter, R. J., Ed. Academic Press: 1981; pp. 59-124), was in the range of −38 to −44.6 mV in solutions with ionic strength of 0.1 mM ata pH of 9.0 (Table 1).

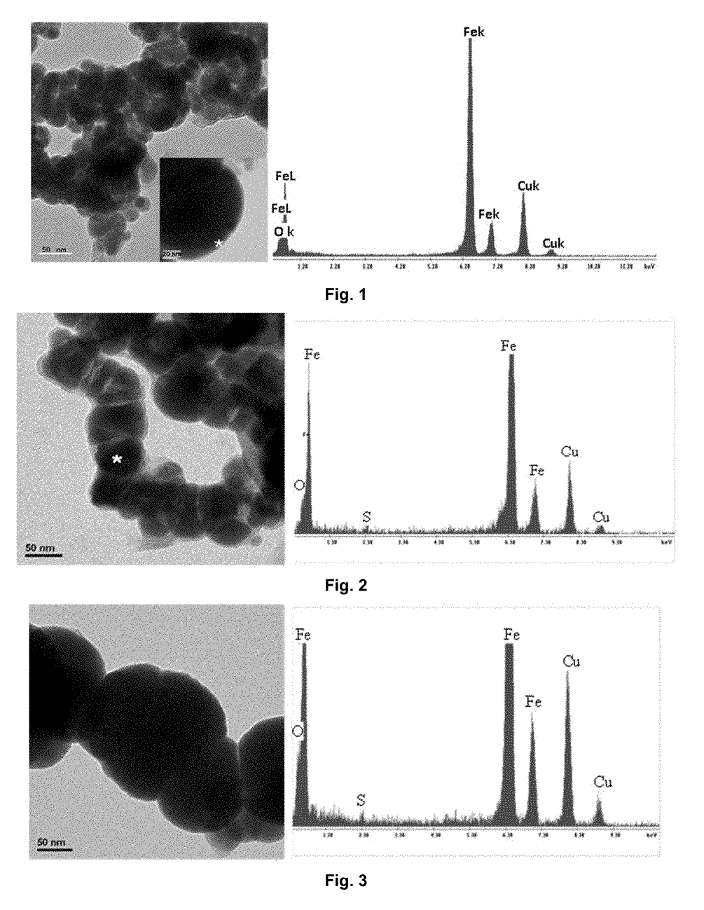

The NZVI and sulfidated NZVI samples were characterized using TEM coupled with energy dispersive X-ray spectra (EDS) for analysis and elemental mapping. FIG. 1 shows NZVI with primary particle diameters between 20 to 80 nm, with a thin oxide shell of less than 4 nm in thickness. FIGS. 2 and 3 show TEM images of NZVI amended with two different doses of sulfide: 0.038 mM and 0.064 mM sulfide, which corresponds to Fe/S molar ratios of 25 and 15, respectively. These ratios of Fe/S for sulfidated NZVI suspensions are calculated on the basis of total iron and total sulfide in the suspension. Both these sulfidated NZVI samples had similar morphology to the unamended NZVI particles.

EDS measurements of NZVI particles showed peaks for Fe and O only (FIG. 1), whereas for sulfidated NZVI the measurements showed peaks for Fe, O and S (FIGS. 2 and 3). The results from TEM-EDS analyses indicate that the sulfidated NZVI had a shell comprised of both iron oxides and iron sulfides. The S peak was relatively larger for the NZVI system amended with the higher dose of sulfide (Fe/S=15), suggesting increased sulfide on the particles.

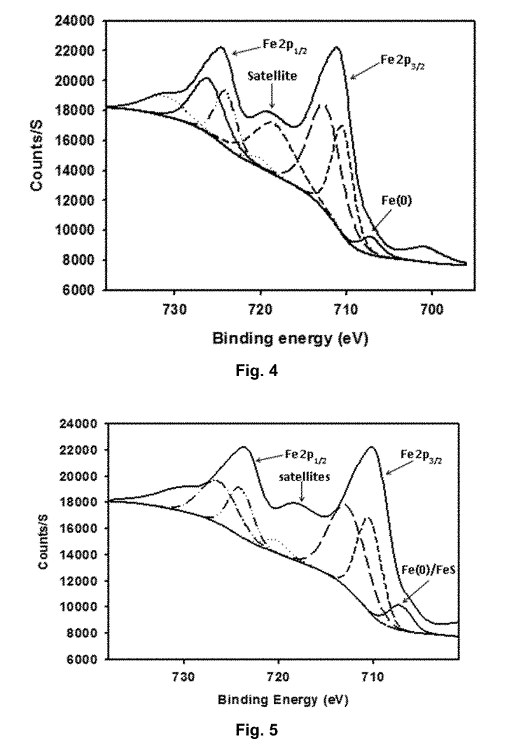

XPS analyses were conducted to compare the surface composition of bare and sulfidated NZVI, and to characterize the distribution of S along the particle depth at different sulfide doses. The XPS spectra of unamended NZVI showed the presence of Fe(II) and Fe(III) oxides and oxyhydrides, as well as the presence of Fe(0), as shown in FIG. 4. The relative abundance for B, Fe, Na and O on the surface based on low resolution survey scans are shown in Table 2.

TABLE 2
Relative atomic abundance from XPS:

| Sample | Binding Energy | Relative At % |
|---|---|---|
| NZVI | | |
| O(1s) | | |
| O2− | 529.9 eV | 16.4 |
| O2− | 530.9 eV | 22.3 |
| OH⁻ | 531.8 eV | 20.4 |
| Fe2p3/2 | | |
| Fe(0) | 707.3 eV | 1.5 |
| Fe(II)—O | 710.5 eV | 12.3 |
| Fe₃O₄ and FeO(OH) | 712.6 eV | 18.3 |

NZVI - 0.86 mM of sulfide (Fe/S = 12)

| | | |
|---|---|---|
| S2p3/2 | | |
| S²⁻ | 161.2 eV | 1.8 |
| S₂²⁻ | 162.9 eV | 0.7 |
| O(1s) | | |
| O2− | 529.9 eV | 18.2 |
| O2− | 530.9 eV | 26.1 |
| OH⁻ | 531.8 eV | 20.2 |
| Fe2p3/2 | | |
| Fe(0) | 707.3 eV | 2.4 |
| Fe(II)—O | 710.5 eV | 11.7 |
| Fe₃O₄ and FeO(OH) | 712.6 eV | 15.8 |

NZVI - 17.32 mM of sulfide (Fe/S = 0.62)

| | | |
|---|---|---|
| S2p3/2 | | |
| S2− | 161.2 eV | 12 |
| S₂²⁻ | 162.9 eV | 3.4 |
| O(1s) | | |
| O2− | 529.9 eV | 6.9 |
| O2− | 530.9 eV | 13.8 |
| OH⁻ | 531.8 eV | 5.3 |
| —O | 533.3 eV | 4.7 |
| Fe2p3/2 | | |
| Fe(0) | 707.3 eV | 12.3 |
| FeS | 709.3 eV | 9.8 |
| Fe(II)—O | 710.5 eV | 7.4 |
| Fe₃O₄ and FeO(OH) | 713 eV | 11.4 |

The XPS data suggest that the unamended NZVI particles have a typical structure comprised of an iron oxide shell with Fe(0) core. Based on high resolution scans for the Fe 2p3/2 spectra (FIG. 4), deconvoluted peaks were obtained for Fe(II) at 709.0 eV, and for Fe(III)-O species represented by a broad peak between 710.0 eV and 717.0 eV. Peaks with binding energy of 712.6 eV suggest the presence of Fe2O3, Fe3O4 and FeO(OH). A relatively small peak was observed at 707.3 eV corresponding to Fe(O) and the low signal is attributable to the fact that the X-ray probing depth was less than 5 nm. Similarly, high resolution scans for oxygen at 529.9±0.3 eV indicate the presence of oxide and the spectra in that region can be fitted to that for magnetite (Fe3O4). The oxygen assignments at binding energies 530.9 eV and 531.8±0.3 eV suggest the formation of oxides and hydroxyl species of Fe.

Survey scans for 0.6 g/L NZVI amended with sulfide (Fe/S=12) showed peaks of Fe, Na, O and S. The high resolution scans for Fe 2p_{3/2} (FIG. 5) yielded similar peaks as observed with unamended NZVI, and binding energies at 710.5 eV and 712.6 eV are attributed to Fe(III)-O and FeO(OH). The peak at 707.3 eV can be attributed to Fe(O) and, in conjunction with the data obtained from high resolution spectra of S 2p, to iron monosulfides (e.g., amorphous FeS or mackinawite) as well. The S 2p spectrum (FIG. 4) consisted of two peaks. The peak with binding energy at 161.2±0.3 eV is typically attributed to iron monosulfide (FeS) and that at 162.9 eV is attributable to iron disulfide (FeS₂). The relative atomic abundance of S as disulfide increased with sulfide dose indicating higher amounts of FeS₂ formation compared to FeS (Table 3).

TABLE 3
Relative abundance of iron from XPS with different doses of
sulfide; b) Relative abundance of iron from XPS before and
after washing

| | Sulfide | | |
|---|---|---|---|
| | Concentration | | |
| Nanoparticle | (mM) | FeS % | FeS₂ % |
| NZVI only | — | — | — |
| NZVI (Fe/S = 36) | 0.036 | 0.7 | 0.3 |
| NZVI (Fe/S = 22) | 0.058 | 1.8 | 0.5 |
| NZVI (Fe/S = 12) | 0.116 | 2.6 | 0.9 |

Equations 1-5 represent key reactions expected to occur on the surface of NZVI during sulfidation, and are in agreement with our XPS analysis.

Fe+2H₂O→Fe(OH)₂+H₂ (1)

Fe(OH)₂ [symbol] Fe²⁺+20H⁻ (2)

Na₂S+H₂O→2Na⁺+HS⁻+OH⁻ (3)

Fe²⁺+2HS⁻→FeS+H₂S (4)

2FeS+2H⁺→FeS₂+Fe²⁺+H₂ (⁵)

To determine if FeS was predominantly present on the NZVI surface or uniformly throughout the particle, depth profiling analysis was conducted by XPS. To date, there are no reports indicating whether the FeS formed is abundant on the surface of the NZVI only, or if FeS is distributed through the particle depth.

NZVI amended with sulfide 1.56 mM (Fe/S=22) was analyzed for its relative atomic abundance from the spectral analysis and yielded a surface Fe/S atomic ratio of 8.62 (before sputtering). The sample was then subjected to an Ar⁺ ion beam (3 kV) that etches (sputters) the NZVI surface to acquire elemental composition at greater depths from the surface. The sputtering yield for the Fe and S are similar, with rate of sputtering for Fe being 1.15 times that of S. The analyses herein show that the surface Fe/S atomic ratio for the sputtered sample was 28.6, three times higher than the non-sputtered sample, as shown in FIG. 5. This clearly indicates that sulfides are present predominantly at the surface of NZVI. Iron nanoparticles have been shown to react with other elements in a manner that results in atom redistribution leading to hollowed-out structures or other atoms at the core, as a result of the Kirkendall effect. However, the results provided herein show that sulfidation did not result in the Kirkendall effect, and iron sulfides are present at the surface of the NZVI.

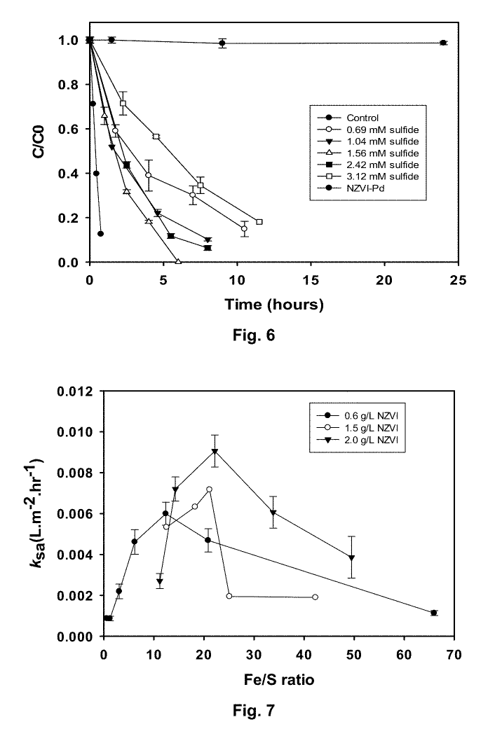

FIG. 6 shows the degradation of TCE in a 2.0 g/L suspension of NZVI amended with sulfide ions at various concentrations up to 3.12 mM. For the range of sulfide doses employed, TCE degradation was faster with sulfidated NZVI, compared to the unamended NZVI system. The TCE degradation rate increased with increasing doses of sulfide from 0.69 mM to 1.56 mM (Fe/S ratio of 50 to 22). However, the TCE degradation rate decreased from that achieved at 1.56 mM sulfide in the presence of higher concentrations of sulfide. The reactor containing NZVI amended with 1.56 mM sulfide degraded TCE completely over a period of 6.5 h, which represents a significantly higher TCE degradation rate compared to that obtained from the reactor containing NZVI only that degraded 5% of the initial TCE over the same period. The reactor with NZVI sulfidated with a higher dose of sulfide (Fe/S=11) degraded TCE by only 58% in 6.5 h. TCE degradation time profiles for reactors containing a lower concentration of sulfidated NZVI, comprised of 0.6 g/L NZVI and 0.173 mM to 17.3 mM sulfide (Fe/S=0.62 to 66) are presented in FIG. 8. In those systems, the TCE degradation followed similar trends with the 2.0 g/L sulfidated NZVI systems, although the TCE degradation occurred over a longer time period. Similar changes in NZVI concentration did not alter TCE degradation rates in the sulfide-free systems.

TCE degradation over time occurred concurrently with evolution of acetylene and ethene in both NZVI and sulfidated NZVI systems, suggesting degradation by β-elimination as a dominant degradation pathway. There was negligible change in the TCE concentration over time for reactors containing TCE and sodium sulfide but no NZVI, indicating that the sulfide ions did not degrade TCE and that losses due to volatilization were negligible.

The TCE degradation kinetics were not limited by the rate of reaction between NZVI and sulfide. Two different sulfidated NZVI with the same concentrations of NZVI (2.0 g/L) and sulfide (1.56 mM), but prepared with contact times of 10 min and 15 h, provided very similar TCE degradation rates.

The surface-area normalized degradation rate constant, k_{SA} (L·m⁻²·h⁻¹) was obtained from the pseudo-first order TCE degradation rate constant, k_{obs} (h⁻¹), using Equation 6.

$$\frac{- dC}{dt} = {k}_{obs} C = {k}_{SA} {α}_{s} {ρ}_{m} C \qquad ( 6 )$$

where C (mg/L) is the TCE concentration, αₛ (m²/g) is the surface area of the particles, ρₘ (g/L) is the concentration of the NZVI. The BET specific surface areas of the NZVI sulfidated at different sulfide doses and the unamended NZVI were similar, in the range 21 to 26 m²/g, with a mean value of 25 m²/g.

In one embodiment, the BET specific surface areas of a sufidated NZVI measured in the range of 21 to 26 m²/g, or a mean value of 25 m²/g.

FIG. 7 presents the surface area-normalized rate constants at different molar ratios of Fe and S (Fe/S ratio). For the 2.0 g/L NZVI systems, the values of k_{SA} increased from 2.2×10⁻⁴ L·m⁻²·h⁻¹ for the unamended NZVI to 9.06×10⁻³ L·m⁻²·h⁻¹ for the sulfidated NZVI with Fe/S ratio of 22. This is a 40-fold increase in the reaction rate constant compared to that for unamended NZVI (Table 1). The reaction rate constant decreased with increasing Fe/S ratios, to 2.7×10⁻³L·m⁻²·h⁻¹ at an Fe/S ratio of 12. Similar trends were observed with the 1.5 g/L and 0.6 g/L systems. For various NZVI loadings, higher k_{SA} values were observed for the Fe/S ratio in the range of 12 to 25, suggesting this is an optimal range of Fe/S for TCE degradation under different NZVI concentrations conditions. The reasons for changes in TCE degradation rates with sulfide dose are discussed in the next section.

In Table 4, the TCE degradation rate constants for systems containing NZVI in the presence of various sulfide concentrations are compared with rate constants with systems containing only NZVI, FeS and NZVI-Pd. The observed TCE degradation rate constant increased in the following sequence FeS<NZVI<sulfidated NZVI<NZVI-Pd. The higher reactivity of the sulfidated NZVI than unamended NZVI cannot be attributed to additional intrinsic reactivity contributions from the FeS formed on the NZVI because there was a decrease in the degradation rate constant at high sulfidation doses.

TABLE 4
Pseudo first order degradation rate constants for 2.0 g/L
suspensions of unamended and sulfidated NZVI, and
0.1 g/L suspensions of NZVI-Pd.

| Sample | | k_{obs} (h⁻¹) | kₛₐ (L · m⁻² · h⁻¹) |
|---|---|---|---|
| Sulfidated | Fe/S = 50 | 0.193 ± 0.015 | 0.39 × 10⁻² |
| NZVI | Fe/S = 33 | 0.303 ± 0.012 | 0.61 × 10⁻² |
| | Fe/S = 22 | 0.453 ± 0.012 | 0.91 × 10⁻² |
| | Fe/S = 15 | 0.360 ± 0.009 | 0.72 × 10⁻² |
| | Fe/S = 11 | 0.135 ± 0.006 | 0.27 × 10⁻² |
| | AGW-1¹ (Fe/S = 22) | 0.338 | 0.67 × 10⁻² |
| | AGW-2² (Fe/S = 22) | 0.351 | 0.70 × 10⁻² |
| | CMC-NZVI (Fe/S = 22) | 0.223 ± 0.014 | 0.86 × 10⁻² |

| | | |
|---|---|---|
| NZVI | 0.012 ± 0.002 | 0.22 × 10⁻³ |
| NZVI-Pd³ | 3.34 ± 0.27 | 0.668 |

¹Recipe for AGW-1 (Middeldorp et al. Water Science and Technology 1998, 37, (8), 105-110): —NH₄Cl (1 mM), MgCl₂ (0.05 mM), MnCl₂ (0.02 mM), NaCl (0.12 mM), CaCl₂ (6 mM), Na₂HPO₄•2H₂O (0.45 mM), KH₂PO₄ (0.15 mM), Na₂SO₄ (1 mM), NaHCO₃ (1 mM);
²Recipe for AGW-2 (Kao et al. Chemosphere 2001, 44, (5), 925-934): NH₄Cl (10.7 mM), CaCl₂•2H₂O (44.1 mM), Mg₂SO₄•7H₂O (98.6 mM), Na₂HPO₄ (1263.8 mM), H₂PO₄ (326.4 mM);
³0.1 g/L NZVI-Pd (Pd-0.5% wt/wt).

TCE degradation experiments were also carried out with sulfidated carboxymethyl cellulose (CMC, 90 kDa) coated NZVI, and the reaction rate constant was only slightly diminished by the CMC coating on the NZVI surface. CMC is a polyelectrolyte that has been shown to be effective for colloidal stabilization of NZVI, and for increasing its potential for transport in subsurface granular media. The comparable reactivity of CMC-coated and bare sulfidated NZVI suggests that long-chain polyelectrolytes that bind to the NZVI surface through interactions of carboxylate groups do not significantly diminish interactions of sulfide with the NZVI surface.

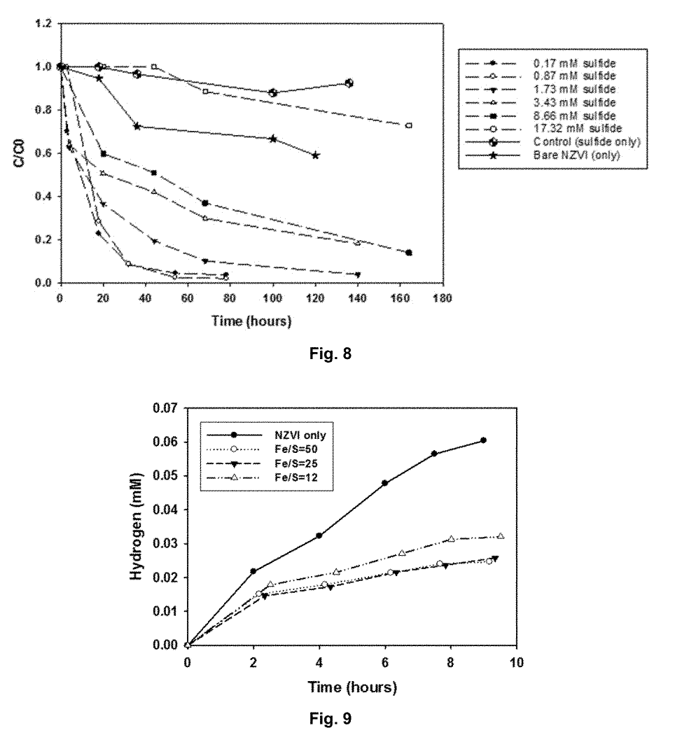

Hydrogen evolution from reaction of unamended NZVI and sulfidated NZVI (Fe/S=50, 25, and 12) with water was assessed to better understand their intrinsic reactivity. Hydrogen is produced by the corrosion reaction of NZVI with water. The hydrogen evolution rate from the unamended NZVI was 5.81 h⁻¹, and was significantly higher compared to that for sulfidated NZVI with Fe/S=12, 25, and 50 at 1.45 h⁻¹, 1.64 h⁻¹, and 2.19 h⁻¹, respectively (FIG. 9). The fact that sulfidated NZVI caused significantly higher TCE degradation than bare NZVI, and yet evolved H₂ at a slower rate, is counter-intuitive. Several conclusions can be inferred from FIG. 9. First, hydrogen evolution by the sulfidated NZVI suggests the TCE degradation occurs through direct electron transfer. Secondly, the sulfide dose influences the hydrogen evolution rate. Thus, hydrophobic FeS layer on the sulfidated NZVI enhances local adsorption of TCE and conducts more electrons to TCE molecules compared to unamended NZVI. Sulfide minerals are more hydrophobic compared to iron oxides. It has been reported that iron sulfides formed on the surface of granular iron have been shown to conduct delocalized electrons in its planar layer. Lastly, the poor reactivity of unamended NZVI is likely due to electrons released rapidly from NZVI being conducted preferentially to water. H₂ production in TCE-containing systems could not be measured due to interferences of TCE with the GC TCD detector.

The optimal sulfide dose (Fe/S=25) for TCE degradation rate had a lower rate of hydrogen evolution (1.64 h⁻¹) than the NZVI sulfidated at higher dose (2.19 h⁻¹ at Fe/S=12). The higher rate of H₂ production by the Fe/S=12 sample can be caused by H₂ generation by the FeS₂ according to the reaction in Equation 5. Higher amounts of FeS₂ were formed at high sulfidation doses. Furthermore, it is likely that cracks and discontinuities develop in the FeS layer at higher sulfidation doses, thus exposing the underlying NZVI surface to the aqueous media.

A relatively small amount of aqueous sulfide was present during the TCE degradation experiments discussed above. Upon adding HS-(Na₂S) to NZVI for sulfidation at Fe/S=12, the initial aqueous sulfide concentration decreased from 687 μM to 166 μM within 10 minutes of addition of sulfide. A residual aqueous sulfide concentration of 10 μM was detectable even after 15 hours of continuous mixing. The aqueous sulfide concentrations for sulfidated NZVI with Fe/S=12 decreased from 3118 μM to 300 μM over 12 hours. Most of the sulfide initially added is removed from the aqueous phase to form iron sulfide phases on the NZVI surface as determined in the XPS analyses, but some sulfide ions may only be sorbed to the sulfidated NZVI surface.

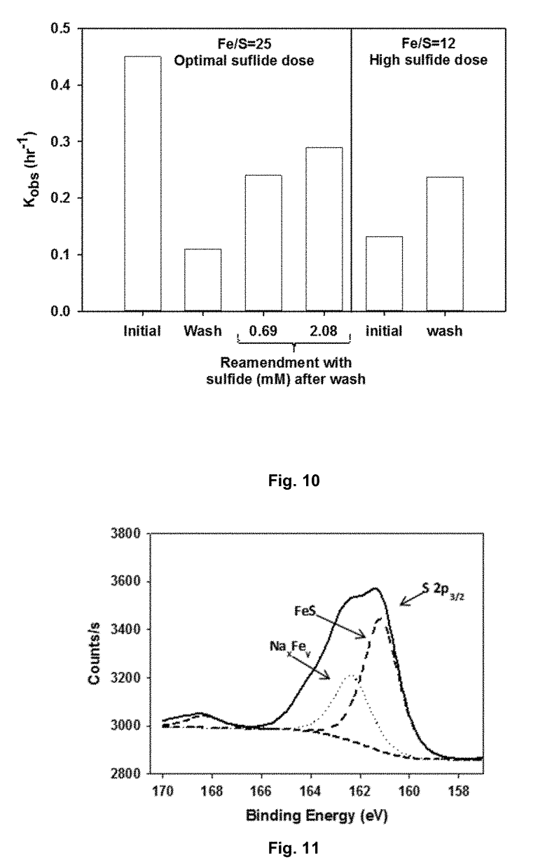

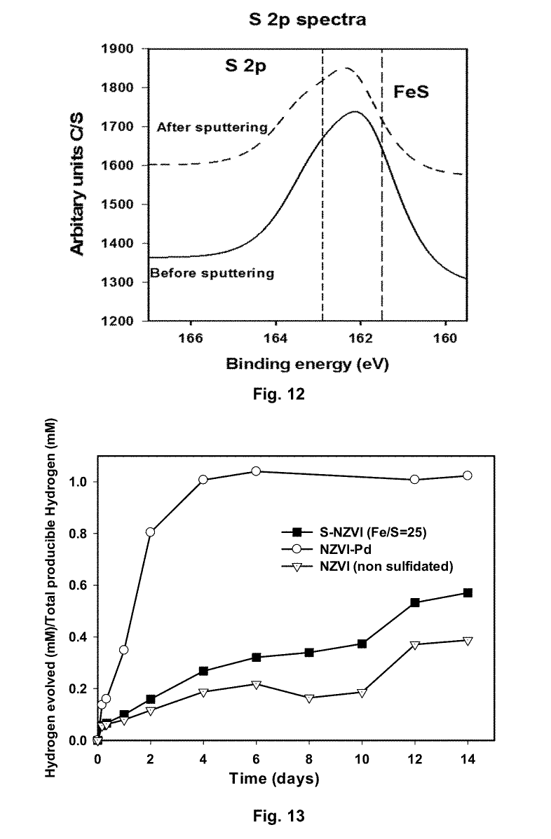

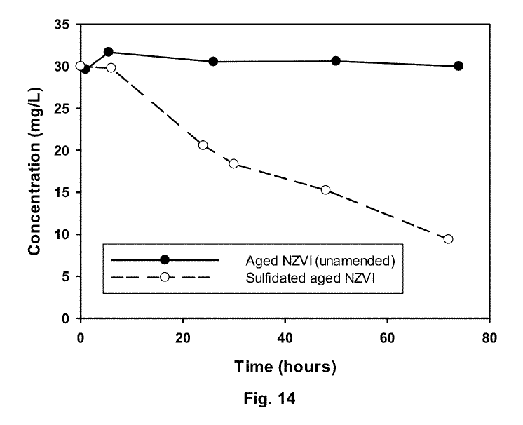

To investigate the reactivity of the sulfidated NZVI to TCE upon removal of the residual aqueous sulfide, the aqueous phase was replaced with sulfide-free aqueous media prior to reactions with TCE. This was evaluated for the optimal and highest sulfide dose (Fe/S=25 and 12) and the results are shown in FIG. 10. In these experiments, the sulfidated NZVI was separated from the supernatant by centrifugation and magnetic separation, and then re-suspended in fresh sulfide-free HEPES buffer solution (adjusted to pH 11 to maintain the same pH as the discarded supernatant). Immediately following this, TCE was added into reaction vials and TCE degradation profiles with the sulfidated NZVI (Fe/S=25) show that there was a decrease in the TCE degradation rate constant from 0.453 h⁻¹ to 0.110 h⁻¹. The decrease in reactivity cannot be attributed to removal of aqueous sulfide only. This is because XPS analysis indicates a decrease in S abundance relative to Fe in the iron sulfide surface layer after washing (Fe/S atomic ratio increased from 35 to 44 as determined from XPS), and this suggests that some of the FeS from the particles had been removed. The loss of FeS due to dissolution is unlikely, as neither dissolved sulfide nor dissolved Fe was not detected in the fresh HEPES buffer contacted with the sulfidated NZVI sample (detection limits: 0.1 mg/L for sulfide and Fe).

Furthermore, the Ksp for FeS is 1.437×10⁻¹⁷. It is possible that some mass of FeS was broken off from the sulfidated NZVI surface during washing.

Nevertheless, when the vials containing the washed sulfidated NZVI were re-spiked with various doses of sulfide (0.173 to 0.692 mM), the reactivity increased. FIG. 10 shows that re-spiking of sulfide resulting in increased reaction rate constants with sulfide addition (0.304 h⁻¹). This demonstrates that the decrease in reactivity is reversible, and reactivity was restored by the newly amended sulfide which formed fresh iron sulfide on the NZVI surface.

Washing of sulfidated NZVI at Fe/S=12 (higher than optimal sulfide dose) enhanced its reactivity towards TCE to 0.240 h⁻¹, compared to 0.135 h⁻¹ prior to washing. It is likely that removal of some amounts of FeS and FeS₂, as confirmed by XPS analyses and likely due to break off from the outer layer during washing, contributed to the higher reactivity.

TCE degradation rates by sulfidated NZVI were dependent on solution pH. Sulfidated NZVI (Fe/S=12) after washing was re-suspended in HEPES buffer with different initial pH of 7, 9, and 11. Results indicate that increasing solution pH significantly increased the TCE degradation rate constant (from 0.104 h⁻¹ at pH 7, to 0.137 h⁻¹ at pH 9, to 0.240 h⁻¹ at pH 11). Increased deprotonation of FeS at higher pH increases the electron availability at reactive surfaces.

TCE degradation by NZVI (2.0 g/L) amended with optimal sulfide dose (Fe/S=22) were tested in two different artificial groundwater samples, AGW-1 and AGW-2 (Table 4), to evaluate the effect of common dissolved ions encountered in natural systems. The pseudo first order reaction rate constant decreased slightly (by approximately 25%) when compared with the DI water system. The observed decrease in reaction rate constant is attributed to the interactions of various ions with the sulfidated NZVI surface.

Addition of Na₂S solutions to NZVI resulted in increased reactivity (kₛₐ) by a factor of 5 to 40, depending on the sulfide dose. The present disclosure demonstrates that the amounts of FeS formed on the NZVI surface play a key role in reactivity, and the FeS surface layer acts as a more selective electron conductor, transferring electrons from the electron-rich Fe(0) core to the TCE at the particle surface compared to the iron (hydro)oxide surface layer in unamended NZVI. Lower H₂ gas evolution rates were observed by sulfidated NZVI than the unamended NZVI (FIG. 9), and coupled with the fact that sulfidated NZVI has higher reactivity, more electrons are conducted to TCE by sulfidated NZVI than unamended TCE. The improved reaction with TCE is likely due to the relatively higher hydrophobicity of the FeS layer compared to the (hydro)oxide layer on the surface of unamended NZVI. Sulfidation of NZVI by simple addition of inorganic sulfides prior to injection of the NZVI can potentially achieve higher rates of TCE degradation in the subsurface. The enhancements in reactivity with sulfidation are not significantly altered by coating the sulfidated NZVI with polyelectrolytes such as carboxymethyl cellulose, or by the presence of common ions in groundwater. Sulfidated NZVI degrades TCE by the β-elimination pathway and the degradation products are primarily ethene, ethane, and acetylene. Thus, sulfidated NZVI appears to be suitable for use in remediation of contaminated groundwater.

As observed in the results of experiments on washing of sulfidated NZVI and respiking the aqueous media with sulfide (FIG. 10), the reactivity of sulfidated NZVI changes when sulfide concentrations in the aqueous medium change.

The present disclosure will be more readily understood by referring to the following examples which are given to illustrate embodiments rather than to limit its scope.

### EXAMPLE I

### NZVI Synthesis and Sulfidation

Ferrous sulfate heptahydrate (99%), sodium borohydride (98.5%), palladium acetate and sodium sulfide (99%) used for preparation of NZVI, NZVI-Pd and sulfidated NZVI were purchased from Sigma-Aldrich. Concentrated HCl (37% w/w) and methanol (HPLC grade) were purchased from Fisher Scientific. Deionised water, methanol and other solutions were deoxygenated prior to reaction by bubbling nitrogen gas.

The NZVI synthesis procedure was adapted from Liu et al. (2005, Environmental Science & Technology, 39: 1338-1345). An aqueous solution of 0.07 M FeSO₄. 7H₂O (in 30% methanol) was continuously mixed, while 0.019 M NaBH₄ was added drop-wise using a syringe pump, followed by an hour of mixing. The resulting NZVI suspension was washed three times with methanol and dried under nitrogen. The washed NZVI was stored in sealed vials under a N₂ atmosphere before use.

Sulfidated NZVI was prepared by sonicating (Cole-Palmer 8891 ultrasonicator, 40 kHz) an aqueous suspension of NZVI with a known concentration of Na₂S aqueous solution (0.173−17.32 mM) for 10 minutes. Palladium-doped NZVI (Pd-NZVI, 0.5% by wt Pd) were synthesized as reported by Zhang et al. (1998, Catalysis Today, 40, (4), 387-395.) by adding NZVI particles to ethanol solutions of palladium acetate. The particle suspension was then sonicated for 15 min. All synthesized particles were used immediately for TCE degradation experiments. All synthesis reactions were carried out under a strict inert atmosphere inside an anaerobic glove box (Coy Laboratories, Inc) containing high purity N₂/H₂ (95%:5%).

### EXAMPLE II

### TCE Degradation Experiments

TCE degradation experiments were conducted in batch reactors comprised of 63 mL screw capped Mininert® vials (VICI) containing 37 mL of an aqueous suspension of bare NZVI or sulfidated NZVI (0.6, 1.5 or 2.0 g/L) or Pd-NZVI (0.10 g/L). TCE degradation was initiated by adding TCE from a methanolic stock solution to provide 0.11 mM TCE in the nanoparticle suspensions. The reaction vials were set-up in triplicates and continuously mixed using an orbital shaker at 300 rpm at 22±2° C. The headspace was periodically sampled for Gas Chromatograph-Flame Ionization Detector (GC-FID) analysis of TCE and the degradation products acetylene, ethene, and ethane. Several vials containing aqueous suspensions of NZVI or sulfidated NZVI were analyzed for H₂ evolution by analyzing headspace samples using a GC-TCD (thermocouple detector).

Additional TCE degradation experiments with NZVI and sulfidated NZVI were conducted with different aqueous chemistry conditions as follows: (i) in HEPES buffer adjusted to pH 7.0, 9.0, or 11.0; (ii) in two artificial groundwaters comprised of Mg²⁺, Mn²⁺, Na⁺, Ca²⁺, K⁺, CO₃²⁻, Cl⁻, SO₄²⁻, PO₄³⁻ with compositions as described in Table 4.

Total sulfide in aqueous solutions was measured using iodometric titration (Standard Methods 428D). Total dissolved sulfide measurement in sulfidated NZVI suspensions was performed after separation of the nanoparticles using a super magnet.

### EXAMPLE III

### Particle Characterization

Nanoparticle tracking analysis (NTA) and Dynamic Light Scattering (DLS) were used to measure the particle sizes of unamended and sulfidated NZVI in aqueous suspensions. The NTA measurements were carried out by injecting a diluted sample (20 mg/L) into the sample chamber of NanoSight LM14. In addition, particle size was measured using Dynamic light scattering (DLS) and electrophoretic mobility was measured by laser Doppler velocimetry by as ZetaSizer Nano, Malvern.

TEM imaging of NZVI and sulfidated NZVI was conducted with aqueous suspensions (10 mg/L) placed on copper TEM grids which were dried overnight. Samples were then analysed for their size and morphology on a Philips CM 200 TEM at an accelerating voltage of 200 kV. X-ray counts were obtained using AMT XR41B CCD Camera System and EDS Genesis EDS in bright field mode.

X-ray photoelectron spectroscopy (XPS) studies were performed for NZVI and sulfidated NZVI using a VG Escalab 3MKII instrument. The samples were irradiated using an Al Ka source at a power of 300 W (15 kV, 20 mA). The binding energies of the photoelectrons were calibrated by the aliphatic adventitious hydrocarbon C (1s) peak at 285.0 eV. With survey scan of energy step of 1.0 eV, pass energy of 100 eV, and high resolution scans with energy step of 0.05 eV, pass energy of 20 eV.

Brunauer-Emmett-Teller (BET) specific surface area of NZVI, NZVI-Pd and NZVI amended with different sulfide doses was assessed by measurements of adsorption of N₂ using a Sorptomatic 1990 surface area analyzer (Thermo Fisher Scientific Inc.).

While the present disclosure has been described in connection with specific embodiments thereof, it will be understood that it is capable of further modifications and this application is intended to cover any variations, uses, or adaptations, including such departures from the present disclosure as come within known or customary practice within the art to which the disclosure pertains and as may be applied to the essential features hereinbefore set forth, and as follows in the scope of the appended claims.

What is claimed is:

1. A sulfidated nanoscale zerovalent iron (S-NZVI) wherein said S-NZVI comprises an iron sulfide (FeS) layer on the surface of a nanoscale zerovalent iron (NZVI) and wherein an iron/sulfide molar ratio (Fe/S) is at least 0.6.

2. The S-NZVI of claim 1, wherein the Fe/S molar ratio is 0.62 to 66.

3. The S-NZVI of claim 1, wherein the hydrodynamic diameter of said sufidated NZVI measured from NTA is greater than or equal to about 190 nm.

4. The S-NZVI of claim 1, wherein the Fe/S molar ratio is 15 to 50.

5. A method of producing a sulfidated nanoscale zerovalent iron (S-NZVI) comprising contacting a nanoscale zerovalent iron (NZVI) with a sulfide source in an aqueous medium.

6. The method of claim 5 wherein said step of contacting a NZVI with a sulfide source is conducted in an inert atmosphere.

7. The method of claim 5 wherein said sulfide source is providing a sulfide species HS-.

8. The method of claim 5 wherein said sulfide source is Na₂S.

9. The method of claim 5 wherein said NZVI is prepared by reduction of a ferrous salt using a borohydride reducing agent.

10. A method for reducing a concentration of a chlorinated organic compound in an aqueous medium comprising contacting said aqueous medium with a sulfidated nanoscale zerovalent iron (S-NZVI) as defined in claim 1.

11. The method of claim 10, wherein said chlorinated organic compound is a chlorinated solvent.

12. The method of claim 10, wherein said chlorinated organic compound is trichloroethylene (TCE).

13. The method of claim 10, wherein said S-NZVI has a Fe/S molar ratio of 5 to 25.
